(19) United States
(12) Patent Application Publication
(10) Pub. No.: US 2011/0186565 A1
(43) Pub. Date: Aug. 4, 2011

(54) HEATING ASSEMBLY WITH INDUCTIVE COIL

(75) Inventors: Chien-Lung CHENG, Yunlin County (TW); Shyi-Ching Chern, Yunlin County (TW); Jim-Chwen Yeh, Yunlin County (TW); Guan-Yu Chen, Yunlin County (TW); Ching-Hung Hsieh, Yunlin County (TW)

(73) Assignee: NATIONAL FORMOSA UNIVERSITY, Huwei Township (TW)

(21) Appl. No.: 12/940,487

(22) Filed: Nov. 5, 2010

(30) Foreign Application Priority Data
Nov. 9, 2009 (TW) 98137980

(51) Int. Cl. H05B 6/10

(52) U.S. Cl. 219/635

(57) ABSTRACT

A heating assembly includes two permanent magnets arranged in a spaced manner to define a path therebetween for passage of a plurality of stainless steel nails, and an inductive coil wound around an extending direction of the path in such a way that the inductive coil has a number of loops arranged along two opposite sides of the permanent magnets. Thus, when the stainless steel nails move through the path, the inductive coil can receive a low-intensity operation current to heat the stainless steel nails to a predetermined temperature.

### BACKGROUND OF THE INVENTION

1. Field of the Invention

The present invention relates generally to a heating assembly, and more specifically to a heating assembly, which has an inductive coil to heat a plurality of stainless steel nails.

2. Description of the Related Art

In order to enhance the convenience of operating a nail gun that is in widespread use in the hand tool industry, a plurality of heated nails can be adhered between two tape strips to become a strip of nails. If the nail gun would like to be used in a humid or salty environment, stainless steel nails are better suited for providing optimum corrosion resistance. An oxyhydrogen flame heating are used at present to heat the stainless steel nails to a predetermined temperature where they can be adhered to the tape strips, but it is necessary to be careful in using the oxyhydrogen flame for ensuring safety of a user.

For the sake of reducing the danger of heating process, field-induced heating method is a superior to the above-mentioned heating process. FIG. 1 show a heating assembly 10 for use in a high-frequency heating equipment, including a C-shaped magnet 12 having a notch 122 defined by two free ends thereof for passage of a plurality of stainless steel nails, and an inductive coil 14 wound on the free ends of the C-shaped magnet 12, such that an inductive magnetic flux will be generated in the notch 122 of the C-shaped magnet 12 by offering an operation current to the inductive coil 14. When the stainless steel nails move through the notch 122, a current flow can be induced on each of the stainless steel nails by cutting cross the magnetic field line, and therefore the stainless steel nails can be heated by the power dissipation of the induced current flow donated from the intrinsic resistance of the stainless steel nails.

However, because the heating process for each of the stainless steel nails only effective when moving through the notch 122 in a very short time, the operation current needs to be provided high enough as up to 100 A˜200 A for enabling the stainless steel nails to reach the desired heating temperature, probably causing the high-frequency heating equipment to be overloaded due to the excessive operation current.

### SUMMARY OF THE INVENTION

It is one objective of the present invention to provide a heating assembly, which has an inductive coil to heat a plurality of stainless steel nails to a predetermined temperature by offering a low-intensity operation current to the inductive coil.

To achieve this objective of the present invention, the heating assembly provided by the present invention comprises two permanent magnets arranged in a spaced manner to define a path therebetween for passage of a plurality of stainless steel nails, and an inductive coil wound around an extending direction of the path in such a way that the inductive coil has a number of loops arranged along two opposite sides of the two permanent magnets.

When the stainless steel nails pass through the path in turn, a small operation current can be offered to the inductive coil such that the stainless steel nails can be heated to a predetermined temperature by means of the arrangement of the inductive coil.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a plane view of a heating assembly according to a prior art;

FIG. 2 is a perspective view of a heating assembly according to a preferred embodiment of the prevent invention;

FIG. 3 is a lateral view of the heating assembly according to the preferred embodiment of the prevent invention; and

FIG. 4 is a top view of the heating assembly according to the preferred embodiment of the prevent invention.

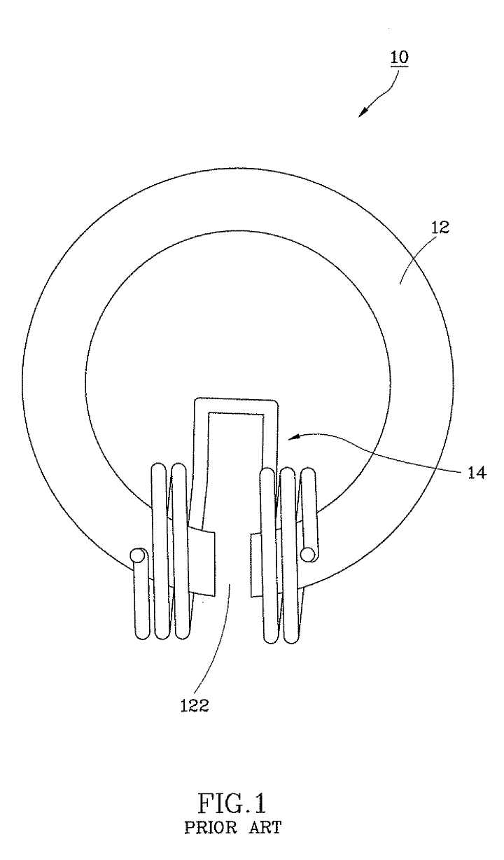

### DETAILED DESCRIPTION OF THE INVENTION

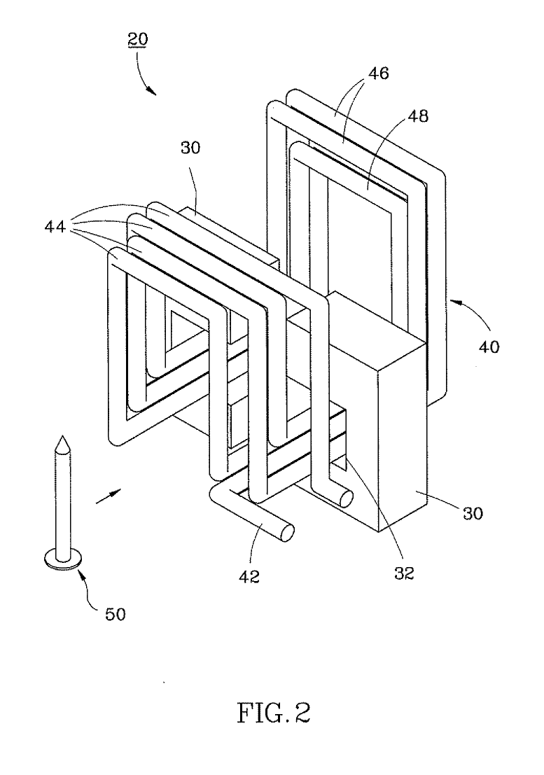

As shown in FIG. 2, a heating assembly 20 in accordance with a preferred embodiment of the present invention comprises two permanent magnets 30 and an inductive coil 40.

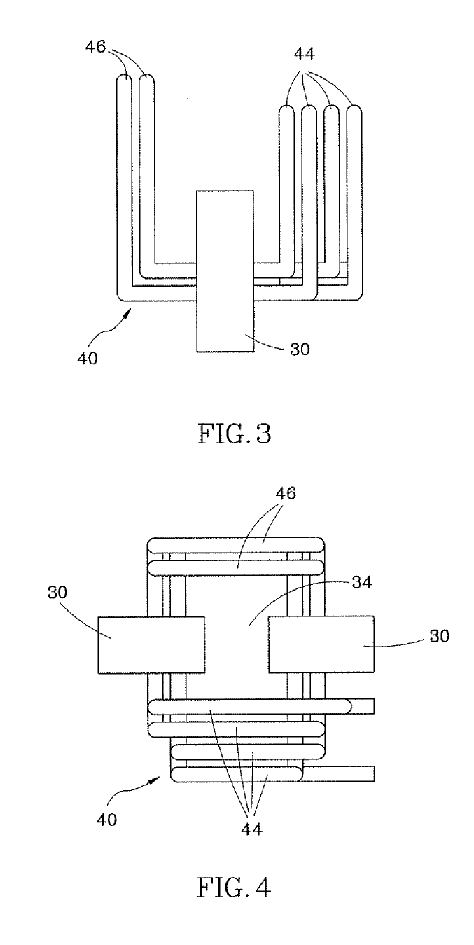

As shown in FIGS. 3 and 4, the permanent magnets 30 each have an indentation 32, and are arranged spacedly in such a way that the indentations 32 of the permanent magnets 30 are faced to each other so as to define a path 34 therebetween for passage of a plurality of stainless steel nails 50.

The inductive coil 40 is formed by a wire 42 that passes through the indentations 32 of the permanent magnets 30 alternately and repeatedly along an extending direction of the path 34, and wound around the extending direction of the path 34 in such a way that the inductive coil 40 has a number of loops at two opposite sides of the permanent magnets 30. In this embodiment, a number of sections of the inductive coil 40 are arranged in the indentations 32 along the extending direction of the path 34 to respectively bridge the loops at the two opposite sides of the permanent magnets 30, and other sections of the inductive coil 40 are formed of the loops having four loops 44 at the front sides of the permanent magnets 30 extending along a direction parallel to the extending direction of the path 34, two loops 46 at the rear sides of the permanent magnets 30 extending along the direction parallel to the extending direction of the path 34, and two loops 48 at the rear sides of the permanent magnets 30 extending along the direction parallel to the extending direction of the path 34; and further, an extending direction from the outer loops 46 to the inner loops 48 is vertical to the extending direction of the path 34. To deserve to be mentioned, the inductive coil 40 can have an equal or different number of loops at the two opposite sides of the permanent magnets 30, that is, the number of loops of the inductive coil 40 is adjustable according to actual needs. For example, the arrangement of the same number of loops at the two opposite sides of the permanent magnets 30 can be designed as two distal ends of the wire 42 located at the same side of the two permanent magnets 30, and the different number of loops at the two opposite sides can be designed as the two distal ends of the wire 42 located at different sides of the two permanent magnets 30. Besides, the inductive coil 40 can be wound only along the direction parallel to the extending direction of the path 34, not limited to the mentioned embodiment with extending in both vertical and parallel direction as the loops 46 and 48.

By means of the aforesaid design, when an operation current is offered to the inductive coil 40, three inductive magnetic fields are respectively generated in the path 34, the core of the loops 44 of the inductive coil 40, and the core of the loops 46 and 48 of the inductive coil 40. Therefore, a current flow can be induced and maintained in each of the stainless steel nails 50 while it moves through the three different regions of the magnetic fields, such that the stainless steel nails 50 can be heated to a predetermined temperature where they can be adhered to become a strip of nails even the operation current offered to the inductive coil 40 is less than that of the prior field-induced heating method.

Accordingly, the heating assembly of the present invention can be configured to increase the time that the stainless steel nails move through the magnetic fields for lengthening the time that the induced current flows in the stainless steel nails by means of changing the winding way of the inductive coil, resulting in that the stainless steel nails can be heated to the desired temperature by offering a low-intensity operation current to the inductive coil,

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A heating assembly for heating a plurality of stainless steel nails, comprising:
two permanent magnets arranged in a spaced manner to define a path therebetween for passage of the stainless steel nails; and
an inductive coil wound around an extending direction of the path in such a way that the inductive coil has a number of loops arranged along two opposite sides of the two permanent magnets.

2. The heating assembly as claimed in claim 1, wherein the inductive coil has the same number of loops at the two opposite sides of the permanent magnets respectively, and two distal ends of the coil located at the same side of the two permanent magnets.

3. The heating assembly as claimed in claim 1, wherein the inductive coil has a different number of loops at the two opposites sides of the permanent magnets respectively, and two distal ends of the coil located at different sides of the two permanent magnets.

4. The heating assembly as claimed in claim 1, wherein the loops of the inductive coil extend along a direction parallel to the extending direction of the path.

5. The heating assembly as claimed in claim 1, wherein a number of the loops of the inductive coil extend along a direction vertical to the extending direction of the path.
